(19) United States
(12) Patent Application Publication
(10) Pub. No.: US 2009/0097620 A1
(43) Pub. Date: Apr. 16, 2009

(54) System and Method for Processing Voicemail Messages Remotely Over A Network Connection

(76) Inventors: Sam J. Kim, Anaheim, CA (US); Hani Hemsi, Irvine, CA (US)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 11/871,869

(22) Filed: Oct. 12, 2007

(51) Int. Cl. H04M 1/64; H04M 11/00

(52) U.S. Cl. 379/88.17; 379/88.18

(57) ABSTRACT

According to one embodiment of the invention, a method comprises establishing communications between a web server and a voicemail system, and thereafter, controlling processing of content stored within the voicemail system by a computing device. The computing device is remotely located from the voicemail system and in communication with the web server.

### FIELD

Embodiments of the invention are generally directed to remote retrieval and processing of voicemail messages, and in particular, to a system and method for controlling the processing of voicemail messages by a voicemail system using a networked computing device.

### GENERAL BACKGROUND

Over the last few decades, voicemail systems have been widely used by businesses to ensure that employees receive important telephonic messages from customers and fellow employees alike. Over the last few years, with growing public acceptance of cellular telephones, individuals now are beginning to use and become more reliant on voicemail systems as well.

Typically, voicemail systems are installed with a central voicemail server connected to a public switched telephone network (PSTN). The PSTN provides registered users of a voicemail system with an ability to access their individual voicemail accounts from most telephones worldwide. Each individual is assigned a voicemail account that is identified by a mailbox number and is allocated with enough storage memory to hold a predetermined number of voicemail messages. However, these voicemail messages can only be reviewed in a sequential fashion, which is time-consuming and frustrating for the user, especially when he or she needs to skip through a number of voicemail messages before accessing the desired voicemail message.

Currently, voicemail systems can be configured to operate with email systems in order to convert voicemail messages stored at the voicemail system into a suitable format for transmission over a local area network or a public network. For instance, voicemail messages can be converted into a .WAV file that is sent to an email system. While conventional voicemail systems allow a user to download voicemail messages as an attachment to an email, these systems do not provide the user with networked access to the voicemail system so that the user has full control over audio processing operations conducted by the voicemail system. Such control would provide the user with greater visibility of what voicemails are stored at the voicemail system.

Moreover, conventional voicemail systems do not provide a displayable list of voicemail messages for viewing or specific control as to playback of audio, including selected playback on different peripheral devices other than a device that is currently accessing the voicemail system. This allows for greater mobility and confidentiality when needed.

### BRIEF DESCRIPTION OF THE DRAWINGS

The invention may best be understood by referring to the following description and accompanying drawings that are used to illustrate embodiments of the invention.

FIG. 1 is an illustrated embodiment of a communication system supporting a voicemail system (VMS) that is accessible by the user via a web server.

FIG. 2 is an illustrated embodiment of a web server implemented with software to support remote voicemail access.

FIG. 3 is an illustrated embodiment of the method of operations for establishing and maintaining communications with a voicemail system through a web server.

FIG. 4 is an illustrative embodiment of the transfer of a message from a web browser of FIG. 1 requesting access to a particular voicemail account within the VMS is shown.

FIG. 5 is an illustrated embodiment a first operation performed by a web server in order to populate web pages supporting VMS Remote Access functionality is shown.

FIG. 6 is an illustrative embodiment of a second operation conducted by the web server of FIG. 1 is shown.

FIG. 7 is an illustrative embodiment of a third operation conducted by the web server of FIG. 1 is shown.

FIG. 8 is an illustrative embodiment of a fourth operation conducted by the web server of FIG. 1 is shown.

FIGS. 9 and 10 are illustrative embodiments of a fifth operation conducted by the web server of FIG. 1, where web server 150 is adapted to retrieve information used to create a message list.

FIG. 11 is an illustrative embodiment of a login screen displayed at the computing device of FIG. 1 for initiating the validation process.

FIG. 12 is an illustrative embodiment of a message list displayed at the computing device of the user is shown.

FIG. 13 is a configuration web page 1300 that allows the user to configure the web page layout and selects the device targeted to receive voicemail for playback.

FIG. 14 is a first illustrative embodiment of a web page generated in response to selection of a second voicemail message contained in the message list of FIG. 12 is shown.

FIG. 15 is an illustrated embodiment of a Reply Message screen format that allows a user to attach and send audio within the voicemail system.

FIG. 16 is an illustrated embodiment of a Voice Forward message screen format that allows a user to attach and send audio within the voicemail system to other users.

FIG. 17 is an illustrated embodiment of a personal address book for owners and mailboxes for voicemail transmissions to the VMS via the web server

FIG. 18 is an illustrated embodiment of an Email Forward message screen format that allows a user to attach and send audio to an email server.

FIG. 19 is an illustrated embodiment of an email address book listing email recipients of audio recorded by the user.

FIG. 20 is a second illustrative embodiment of a web page generated in response to selection of the second voicemail message with the targeted receiving device being a device other than the computing device.

FIG. 21 is an illustrated embodiment of a message screen format that allows a user to view a facsimile transmission and route the facsimile transmission to an intended recipient with an optional voicemail message to be attached.

### DETAILED DESCRIPTION

Embodiments of the invention set forth in the following detailed description generally relate to a system and method for controlling the retrieval, transmission and processing of voicemail messages by a voicemail system (VMS). Such control is performed remotely by or on behalf of a registered user of the VMS using a computing device that is in communication with the VMS via a web server.

According to one embodiment of the invention, the web server operates as an interface between the VMS and the computing device with network connectivity in order to allow users to perform a full range of audio processing operations via a web browser. In order to reduce complexity and avoid any need for synchronization between multiple databases, the web server may be implemented as a “thin web server,” namely a web server without a permanent, dedicated database.

The web server is adapted to retrieve information for populating downloadable web pages and to provide one or more plug-in applications to the computing device once communications are initially established. For instance, according to one embodiment of the invention, the plug-in application is a program that is installed to operate in cooperation with the web browser of the computing device and generates messages for remotely controlling audio processing by the VMS.

In the following description, certain terminology is used to describe various features of one or more embodiments of the invention. For instance, a “computing device” is generally defined as any electronic device having a display and, under the control of the user, being capable of establishing wired or wireless communications over a network in order to download information from or upload information to a networked resource (e.g., web server, email server, etc.). Examples of a computing device include, but are not limited or restricted to a computer (e.g., desktop, laptop, tablet, handheld, server, etc.) or any portable electronic device such as a personal digital assistant (PDA), a cellular telephone, an alphanumeric pager, a music player, or the like.

The term “application” is generally referred to one or more code instructions that perform a particular function or functions. These instructions may be stored within machine-readable medium as firmware or software. “Machine-readable medium” is any medium that can at least temporarily store information including, but not limited or restricted to the following: an electronic circuit, a semiconductor memory device (non-volatile or volatile), a hard disk drive, and various types of portable storage devices (e.g., flash drive, compact disc “CD”, digital versatile disk “DVD”, etc.).

The term “message” is information that is arranged in a predetermined format for transmission over a logical connection, which is a communication session during which information is transmitted over a communication link (e.g., a wired or wireless transmission medium). “Information” includes digitized or analog signals operating as data, address, control or any combination thereof.

I. Exemplary System Architecture

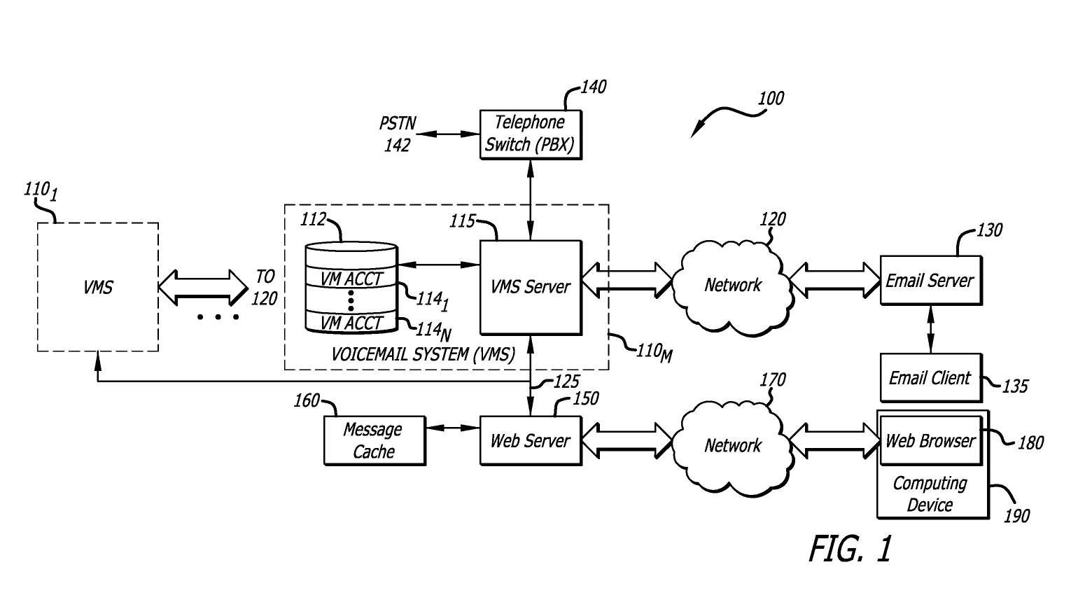

Referring to FIG. 1, an illustrative embodiment of a communication system 100 is shown, where communication system 100 features one or more voicemail systems 110₁-110_{M} (M≧1). Each voicemail system 110₁, . . . , or 110_{M} is accessible by a computing device 190 via a web server 150 when VMS Remote Access functionality is enabled. For clarity sake, the interoperability between web server 150 and one of the voicemail systems, namely voicemail system (VMS) 110_{M}, will be described in detail. Of course, web server 150 may be adapted to communicate concurrently with multiple voicemail systems through successive unicast transmissions each uniquely addressed for a targeted voicemail system or through a multicast or broadcast message targeting these voicemail systems.

According to this embodiment of the invention, VMS 110_{M} comprises a database 112 to store digital content (e.g., voicemail) and a VMS server 115 to communicate with networked devices, including web server 150 over a communication link 125 and/or an electronic mail (email) server 130 over network 120. Network 120 may be a publicly accessible network (e.g., Internet or other wide area network “WAN”), or may be a private network such as some type of local area network (LAN). As shown, communication link 125 is installed as a dedicated interconnect (e.g., peer-to-peer or peer-to-multi-peer), but may be implemented as a public and/or private network.

According to one embodiment of the invention, database 112 is organized by allocating storage for each of a plurality of voicemail accounts 114₁-114_{N} (N≧1). Each voicemail account 114₁, . . . , or 114_{N} is identified by an assigned mailbox number and is configured at set-up to store the user's name, voicemail messages for that particular user, and information associated with each of the stored voicemail messages (hereinafter “voicemail message information”). The voicemail message information may include, but is not limited or restricted to a unique value used to identify the voicemail message (hereinafter “Message_ID”), the time of receipt of the message (hereinafter “VM_Time”), the length of the voicemail message in minutes and/or seconds (hereinafter “VM_Length”), message flags to identify the message type (e.g., email, voicemail, fax, etc.), and encoding type for the message such as the type of compression and/or encryption format (hereinafter “VM_Coding”).

VMS server 115 is also coupled to a telephone switch 140. According to one embodiment of the invention, telephone switch 140 is a private branch exchange (PBX), which is a telephone switching system that interconnects telephone extensions to each other as well as to an outside telephone network, such as a public switched telephone network (PSTN) 142. Of course, it is contemplated that telephone switch 140 may be implemented as another conventional switching mechanism besides a PBX.

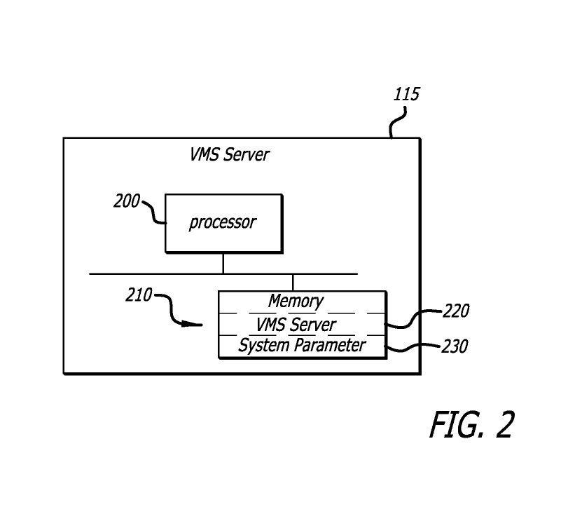

According to one embodiment of the invention, as shown in FIG. 2, VMS server 115 may be implemented as a general purpose computer that includes a processor 200 and a memory 210 adapted to store VMS software 220 that is executed by processor 200 and performs operations normally associated with voicemail systems, including playback of a voicemail greeting message selected by the user, recordation and storage of voicemail messages left for the user, and/or activation of a light to identify that a new voicemail message has been left in the user's voicemail. Although not required, it is contemplated that one or more digital signal processors (DSPs) may also be provided to assist in processing the voicemail messages and/or fax messages.

Memory 210 is further adapted to store system parameters 230 directed to the particular set-up of VMS 110_{M}. For instance, system parameters 230 may include information concerning one or more of the following: a version number of VMS software 220, the voicemail message encoding type, and system time-out values that are used to control cessation of a logical connection over communication link 125 of FIG. 1 based on inactivity for a predetermined period of time or a detected event.

Referring back to FIG. 1, in accordance with this embodiment of the invention, VMS server 115 is loaded with proprietary software to control communications between VMS 110_{M} and web server 150. For instance, in response to a request from web server 150 to establish a logical connection over communication link 125, VMS server 115 validates the request. If the request is determined to be valid, VMS server 115 establishes the logical connection (e.g., communication session), which will remain active until a user or system time-out event occurs for example.

After the logical connection has been established, web server 150 collects information from VMS 110_{M} for subsequent transmission over a network 170 and display by computing device 190. Thereafter, VMS server 115 may be adapted to retrieve and playback a selected voicemail message from a designated voice mailbox and deliver it to computing device 190. Similarly, VMS server 115 may be adapted to receive a voicemail message from computing device 190 via web server 150 and deliver this message to a targeted voice mailbox or place within an email for transmission to an identified email recipient.

As further shown, email server 130 may be implemented as a general purpose computer, including a processor, a memory, a display and an input device such as a keyboard. The computer is programmed to execute an email client 135, such as Lotus® Notes® or Microsoft® Outlook®, which is configured to retrieve and manipulate email messages from email server 130. Although virtually any email client and email server may be utilized in accordance with the invention, in this embodiment, email server 130 may be implemented as an SMTP-compatible email server, and email client 135 is capable of retrieving and manipulating email messages from email server 130.

As also shown, “thin” web server 150 (e.g., web server 150 without a permanent database) is adapted to be in communication with VMS 110_{M}. More specifically, web server 150 includes software modules to allow for detection of request messages from computing devices for information from VMS 110_{M} and to retrieve the requested information from VMS 110_{M}. Web server 150 is configured to communicate with VMS server 115 when a logical connection is requested by computing device 190 via web browser 180 and upon receipt of subsequent requests (messages upon which information is needed from VMS 110_{M}) from web browser 180. Web server 150 includes a message cache 160 to temporarily store certain information downloaded from VMS 110_{M}. Since web server 150 is a “thin” web server, it processes requests substantially in real-time once the request is received from computing device 190 over network 170.

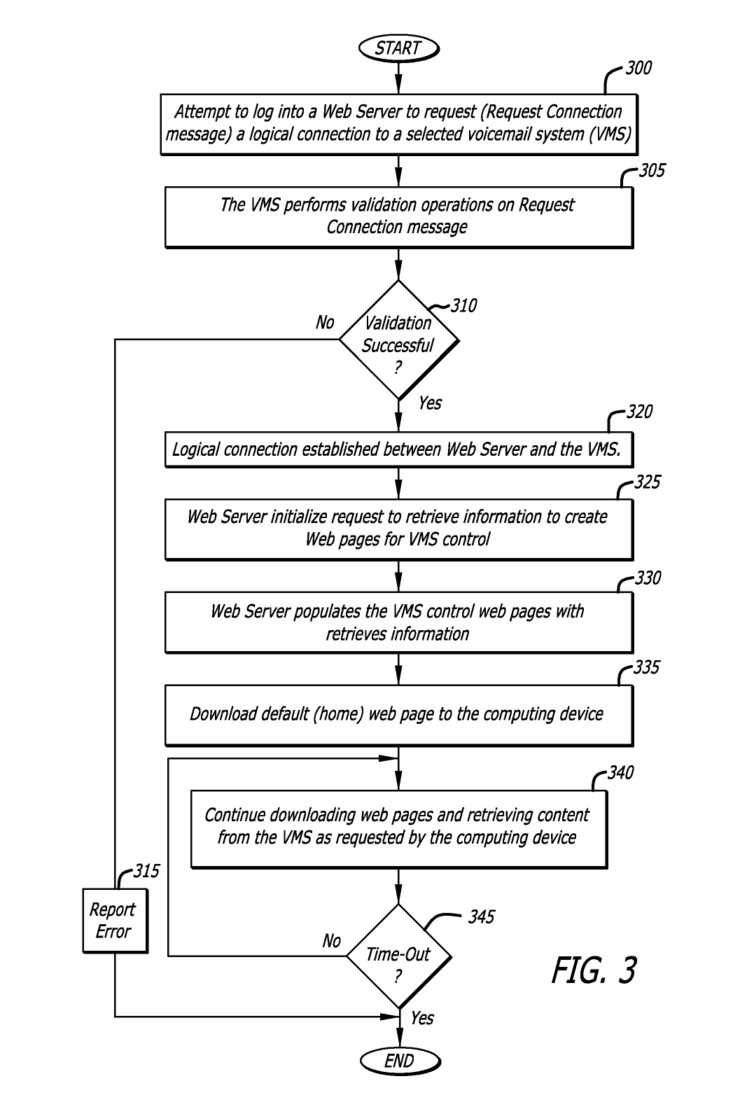

In operation, the user may initiate a call to establish a connection to telephone switch (PBX) 140, and then dials the telephone extension of a registered user of VMS 110_{M}. VMS server 115 of VMS 110_{M} presents the user with a voicemail interface in accordance with the configuration of the user's voice mailbox. Alternatively, a remote user may establish a connection with VMS 110_{M} through web server 150 and retrieve information for allowing the user to access and alter audio stored in VMS 110_{M} via web server 150 as described below in detail (see FIGS. 3-21).

II. Exemplary Configuration Operations

Referring to FIG. 3, an illustrated embodiment of the method of operations for establishing and maintaining communications with a voicemail system (VMS) through a web server is shown. These operations can be divided into three (3) phases: (1) Validation; (2) Data Download; and (3) Web-based VMS Control.

Of course, initially, the VMS is set-up and voicemail accounts are established for the users, where each user is assigned a mailbox number and selects a password needed for accessing his or her voicemail account. Moreover, each user may be provided with an option to enable “VMS Remote Access” functionality if such functionality is an enhanced service that is offered for an additional cost. As a result, the VMS may be configured to obtain billing information or to identify what users, if any, have selected to enable the VMS Remote Access function. This identification would prompt the web server may generate a message to request the user to register his or her billing information. This message may be a pre-recorded audio message requesting the user to visit a web site and register on-line. Alternatively, the message may be an email directly sent to the user (provided the VMS has stored the user's email address).

A. Validation Phase

After the VMS has been set-up and VMS Remote Access functionality has been enabled, in the event that one of the users wishes to remotely access a targeted VMS and retrieve voicemail messages from his or her voicemail account, the user (using a computing device) transmits a request message to log into the web server and request a logical connection to be established between the web server and a targeted VMS (block 300). The logical connection is needed to retrieve information stored within the VMS and download this information to the user's computing device. This request message, referred to as “Request Connection message,” includes (i) information that identifies the targeted VMS (VMS_identifier), (ii) mailbox number of the user (user_mailbox), and (iii) a password input by the user (input_password) as described below.

Thereafter, upon receipt of the Request Connection message, the web server extracts the VMS_identifier, user_mailbox and input_password and creates a new message in accordance with a proprietary communication protocol utilized between the web server and the VMS. This message is forwarded to the VMS over a communication link.

After receiving the message from the web server, VMS extracts user_mailbox and determines whether it supports the inputted mailbox number, and if so, determines whether VMS Remote Access functionality has been enabled. If VMS Remote Access functionality has been enabled, the VMS determines whether the input_password matches the pre-stored password (block 305). If the VMS fails to validate the user, an error is reported (blocks 310 and 315). Otherwise, a logical connection is established between the web server and the targeted VMS in order to download information for populating a navigational web page accessible to the computing device (block 320).

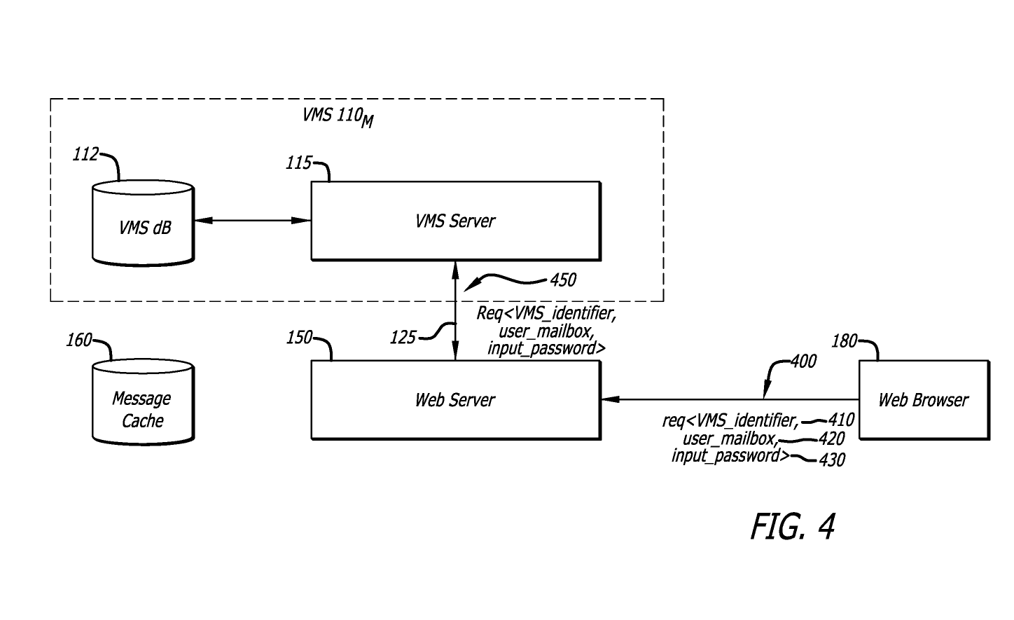

More specifically, as shown in FIG. 4, an illustrative embodiment of the transfer of Request Connection message 400 from web browser 180 of FIG. 1 requesting access to a particular voicemail account within VMS 110_{M} is shown. As shown, Request Connection message 400 includes (i) VMS_identifier 410, (ii) user_mailbox 420 and (iii) input_password 430. VMS_identifier 410 includes address information, represented as alphanumeric characters, to route Request Connection message 400 to web server 150. User_mailbox 420 is a value that identifies a particular voicemail account (mailbox) from which information is to be downloaded while input_password 430 is an alphanumeric value that was entered by the user and will be subsequently compared with the password pre-stored at VMS 110_{M}.

As further shown in FIG. 4, web server 150 extracts VMS_identifier 410, user_mailbox 420 and input_password 430 and creates a message 450 in accordance with a proprietary communication protocol established between web server 150 and VMS 110_{M}. Message 450 is sent over communication link 125 operating as a peer-to-peer connection according to this embodiment of the invention. It is contemplated, however, that link 125 may be configured as a multi-peer connection in which VMS 110₁-110_{M} will be configured to monitor traffic over link 125.

Upon receipt of VMS_identifier 410, user_mailbox 420 and input_password 430, VMS 110_{M} performs the validation operations (password compare, mailbox check, etc.) and, upon successful completion of validation operations, establishes a logical connection with web server 150 of FIG. 1.

B. Download Phase

Referring back to FIG. 3, after successful completion of the Validation Phase, the web server initiates requests for information that is needed to populate web pages that are accessible to the computing device and are used to control audio processing by the targeted VMS (block 325). This information includes one or more of the following: (1) version number of the voicemail system software; (2) user properties; (3) system parameters; (4) all mailbox numbers supported by the VMS; (5) owner names associated with these mailbox numbers; (6) email addresses listed in the user's email address book(s); (7) message identifiers for each of the voicemail messages stored by the user within the VMS; and (8) information related to characteristics of these voicemail messages.

For instance, the “user properties” include information to identify the user as well as his or her preferences. For instance, as an example, the user properties may include, but are not limited or restricted to the user's registered name, the number of lines to be displayed per web page, display refresh values, or the media interface type. “System parameters” include information pertaining to system functionality such as the type of encoding used for the voicemail messages for transmission from the VMS to the web server (“audio encoding type”) as well as system time-out values (e.g., duration of no activity before forced cessation of the logical connection).

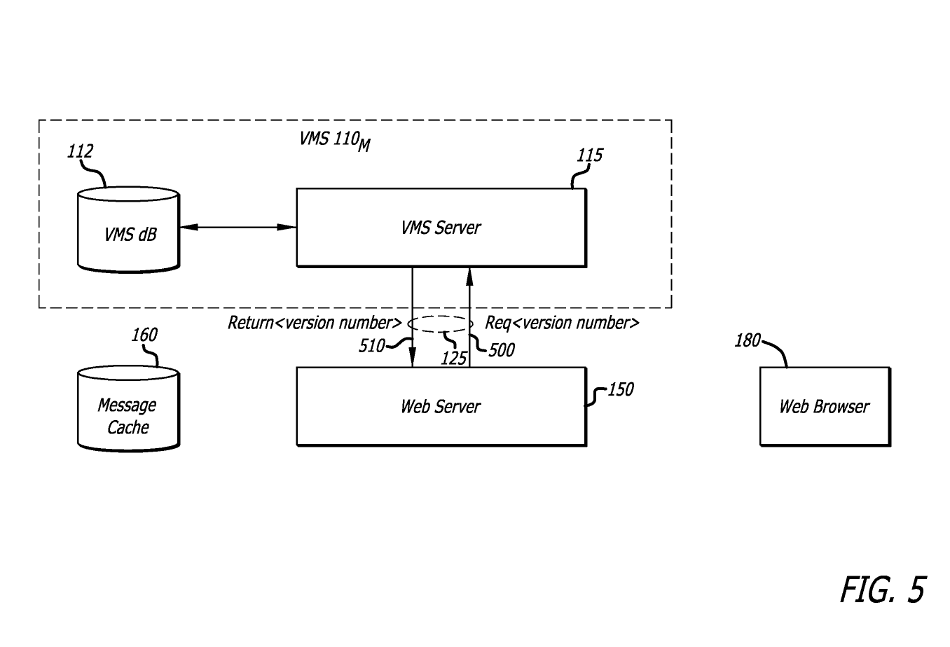

More specifically, as shown in FIG. 5, an illustrative embodiment of a first operation performed by web server 150 in order to populate web pages supporting VMS Remote Access functionality is shown. Web server 150 transmits a request message 500 to VMS 110_{M}, requesting the version number of VMS software 220 stored in VMS 110_{M}. Upon receipt of request message 500, VMS 110_{M} accesses such information and provides a return message 510 to web server 150. Return message 510 includes the version number of VMS software 220 currently running on VMS 110_{M}.

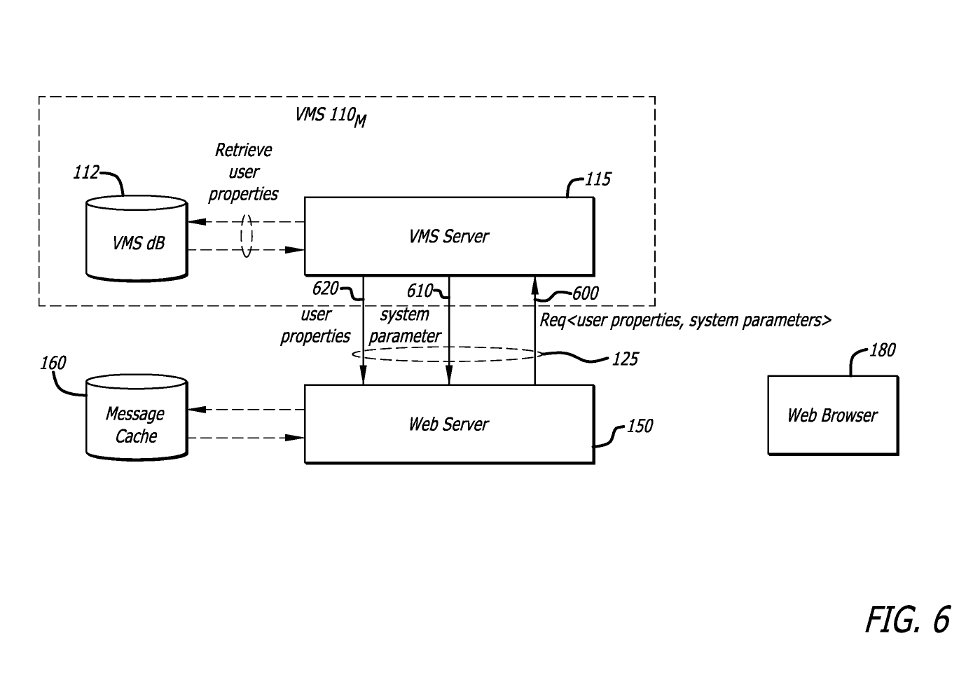

Referring now to FIG. 6, an illustrative embodiment of a second operation conducted by web server 150 is shown. Hence, web server 150 transmits a request message 600 which requests user properties and system parameters stored in VMS 110_{M}. VMS 110_{M} downloads system parameters 610 such as, for example, encoding type and system time-out values. System parameters 610 may be obtained from internal memory within VMS server 115 of VMS 110_{M} or from database 112 associated with VMS 110_{M}.

In addition, VMS 110_{M} downloads user properties 620 to web server 150. User properties 620 are used to personalize the layout of the web pages used in controlling VMS 110_{M}. For instance, as an example, user properties 620 may include, but are not limited or restricted to the following: (1) the user name associated with user_mailbox 420 of FIG. 4; (2) number of lines per web page; (3) number of voicemail messages displayed on a voicemail message list (described below); (4) interim time period between refresh operations for displaying voicemail messages; or (5) the media interface type (e.g., data stream over Internet, transmit over cellular technology via PBX, etc.). User properties 620 are retrieved from VMS database 112 and are stored in memory corresponding to user_mailbox 420 identified in Remote Connection message 400 of FIG. 4.

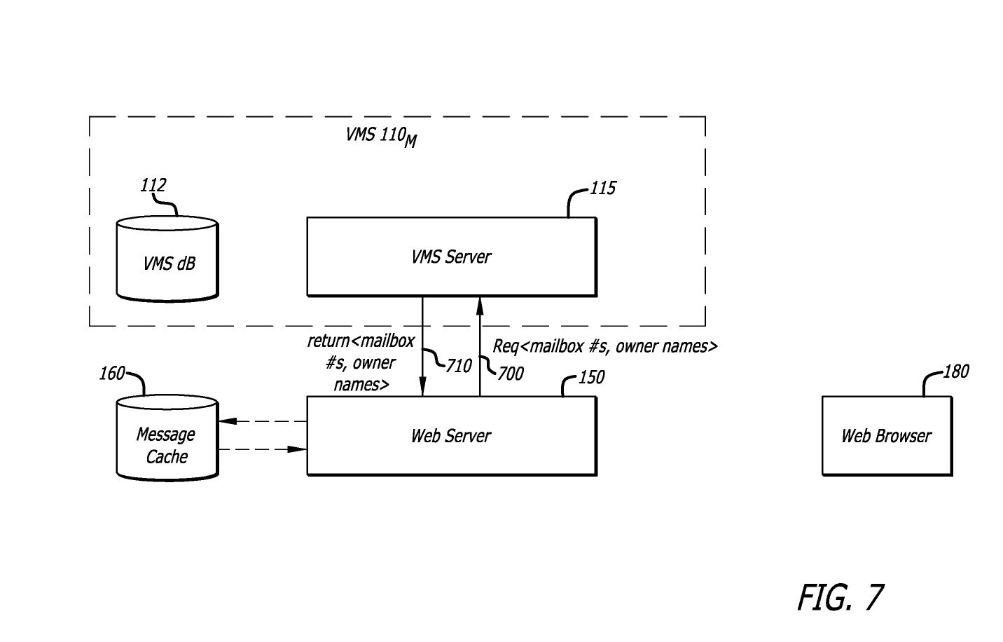

Referring now to FIG. 7, an illustrative embodiment of a third operation conducted by web server 150 is shown. According to this embodiment of the invention, web server 150 transmits a request message 700 for all owner names and mailbox numbers supported by VMS 110_{M}. This information is used to populate address books for assisting in communications between the user and other members of VMS 110_{M}. Upon receipt of request message 700, VMS server 115 of VMS 110₁ accesses VMS database 112 in order to extract the user name and mailbox numbers that are listed throughout VMS database 112. This information 710 is provided to web server 150 in order to create the system address book. Information 710 is stored in message cache 160 and is sent to web browser 180 when the user is viewing a page where such information is needed.

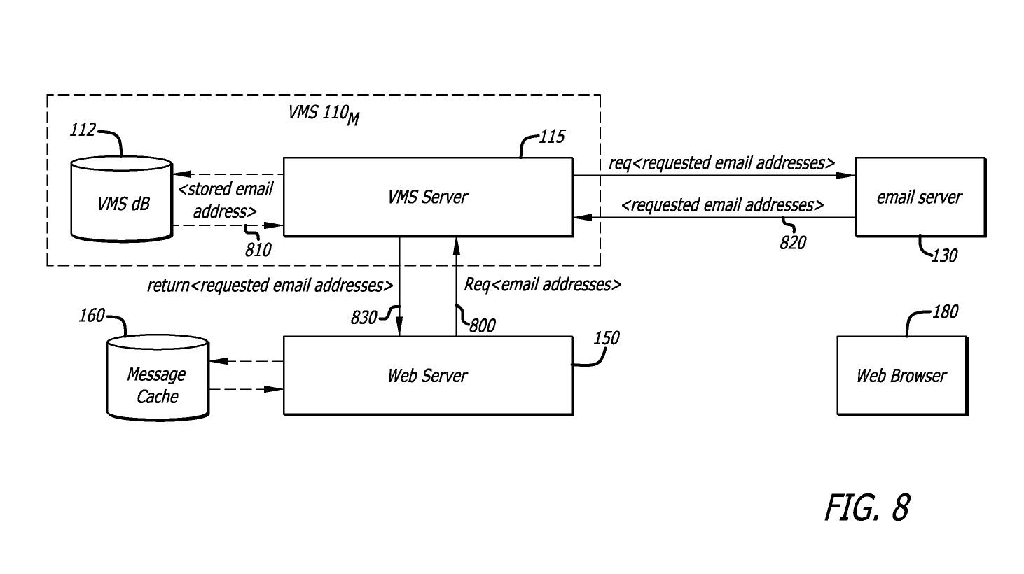

Referring now to FIG. 8, an illustrative embodiment of a fourth operation conducted by web server 150 in order to create a personal address book for the user is shown. According to this embodiment of the invention, web server 150 transmits a request message 800 for email addresses registered by the user. Upon receipt of request message 800, VMS 110_{M} may be adapted to access VMS database 112 in order to retrieve stored email addresses 810 associated with the mailbox number of the user and/or access email server 130 in order to obtain a download of the user's email address book 820. VMS 110_{M} assimilates the information and downloads the requested email addresses 830 to web server 150.

Web server 150 creates a personal address book based on downloaded email addresses 830 in order to provide a personal address book that can be accessed when the user wishes to forward a voicemail message over the Internet. These email addresses 830 are also stored in message cache 160 and sent to web browser 180 when the user requests this information such as, for example, when the user is displaying the address book, or when the user clicks on “To” button to display the address list during message forward/compose/reply.

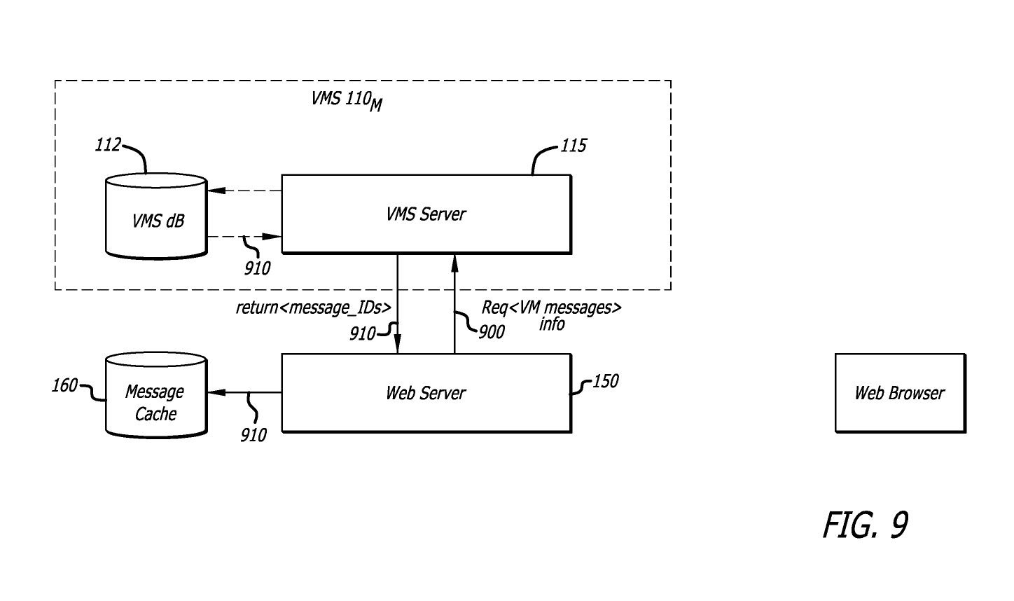

Referring now to FIG. 9, an illustrative embodiment of a fifth operation conducted by web server 150 is shown. Herein, web server 150 is adapted to retrieve information used to create a listing of messages with digital content, referred to herein as a “message list”. In order to create the message list, web server 150 transmits a request message 900 for information associated with voicemail messages stored in the user's voice mailbox account. VMS server 115 accesses VMS database 112 using the user_mailbox in order to obtain identifiers (Message_IDs) 910 for each of the voicemail messages stored in the user's voicemail account. Each voicemail message is associated with a unique Message_ID 910. These Message_IDs 910 are received by VMS server 115 of VMS 110_{M} and routed to web server 150. Web server 150 temporarily stores Message_IDs 910 in message cache 160 being temporarily memory used by web server 150 while the logical connection is active.

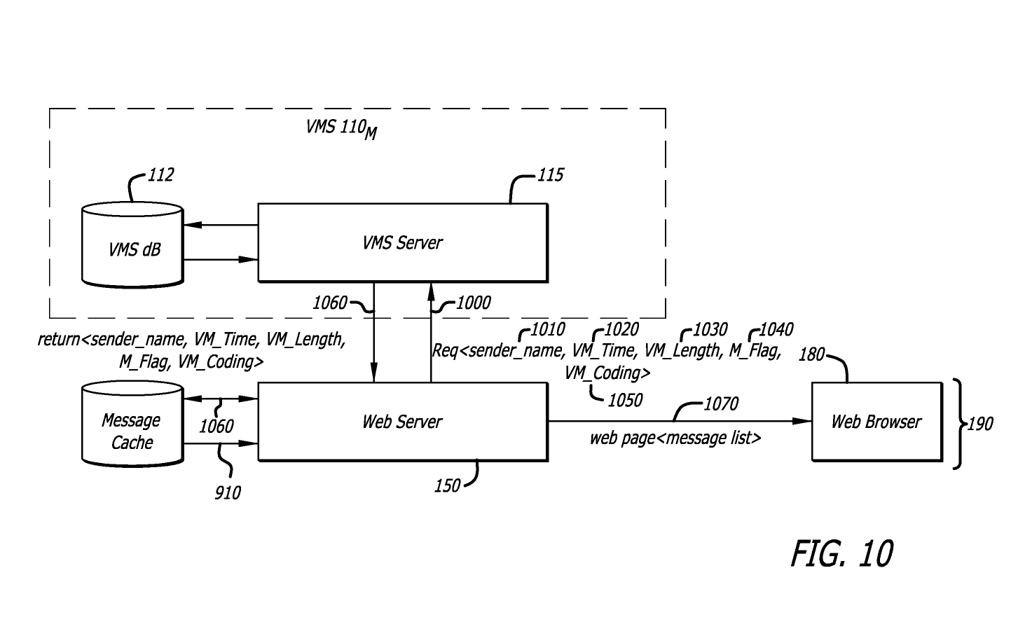

Hereafter, as illustrated in FIG. 10, web server 150 sequentially retrieves Message_IDs 910 previously stored in message cache 160 in order to initiate request messages 1000 to obtain information associated each of the stored voicemail messages. This information includes, but is not limited or restricted to, the name of the sender of the audio message (sender_name) 1010, the time that the voicemail message was received (VM_Time) 1020, the length (duration in seconds) of the voicemail message (VM_Length) 1030, a message flag that identifies priority and/or type of message (M_Flag) 1040, and an encoding type that identifies the coding scheme used in order to compress and/or encrypt the audio message (VM_Coding) 1050.

VMS 110_{M} receives request messages 1000 and accesses VMS database 112 in order to retrieve this information from the user's voicemail account. The requested information 1060 is then transmitted to web server 150 and stored in message cache 160 along with corresponding Message_IDs 910. This process is continued until all of the Message_IDs 910 have been used to retrieve message information 1060 associated with the stored voicemail messages.

Thereafter, web server 150 has sufficient information to populate the web pages and provide the web pages to web browser 180 of computing device 190 as selected by the user. Initially, a default web page 1070 may include the message list as described above.

C. Web-Based VMS Control Phase

Referring back to FIG. 3, upon completion of the Data Download phase, the user may be provided with sufficient visibility of the stored contents within his voice mailbox for the VMS. Since the download has completed, the web server possesses sufficient information to populate downloadable web pages to the computing device to enable the user to control audio processing by the VMS (block 330).

Herein, as also shown in FIG. 10, default web page (e.g., a web page that lists the voicemail messages currently stored in the particular voice mailbox) is provided to the computing device for display (block 335). As selected by the user, the web server is adapted to continue downloading web pages to the user based on requests initiated at the computing device until either a system or user time-out event occurs (blocks 340 and 345).

Hence, during this phase, the user is able to fully control audio processing performed by the VMS. For instance, the user now is able to delete or save messages in the VMS via a web browser. Moreover, the user is able to select and playback voicemail messages on his or her computing device or another selected computing device that is connected to a public network and has an assigned IP address. Additionally, the user is able to record audio and forward the recorded audio to selected voice mailbox or to a selected email address via the web server. Finally, the user is able to forward or reply to a selected voicemail message via the web server.

In the event that a system or user time-out event occurs, the logical connection is terminated. Hence, remote control of the VMS by the computing device is discontinued.

III. Exemplary Web Page Layouts

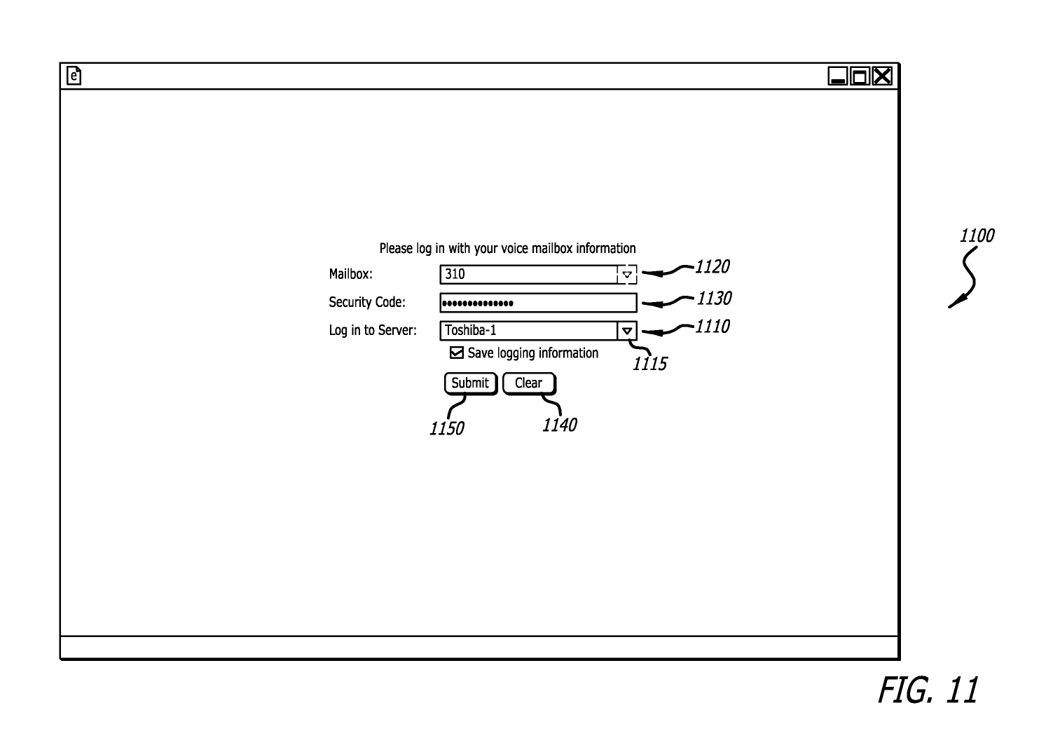

Referring now to FIG. 11, an illustrative embodiment of a login screen 1100 displayed at computing device 190 of FIG. 1 for initiating the validation process is shown. Screen 1100 includes a plurality of input fields; namely, a VMS field 1110, a mailbox field 1120 and a password field 1130. In order for the user to select which VMS to remotely access, the user inputs an IP address of the VMS or selects the VMS name using a pull-down menu 1115 associated with VMS field 1110 as shown.

In addition, the user identifies the mailbox number in which the user is permitted to access. The mailbox number may be input into mailbox field 1120 using an input device associated with the computing device. Alternatively, as optionally shown by dashed lines, the mailbox number may be selected through use of a pull-down menu that lists all of the mailboxes available within the VMS selected in VMS field 1110. Finally, the user inputs a password previously selected by the user to access his or her voicemail account. The password is input into password field 1130.

Upon selecting a “Clear” button 1140, the inputted data is removed from field 1110, 1120 and 1130. Upon selecting a “Submit” button 1150, however, the information contained in fields 1110, 1120 and 1130, formulating VMS_identifier 410, user_mailbox 420 and input_password 430 of Request Connection message 400, is transmitted to web server 150 as shown in FIG. 4.

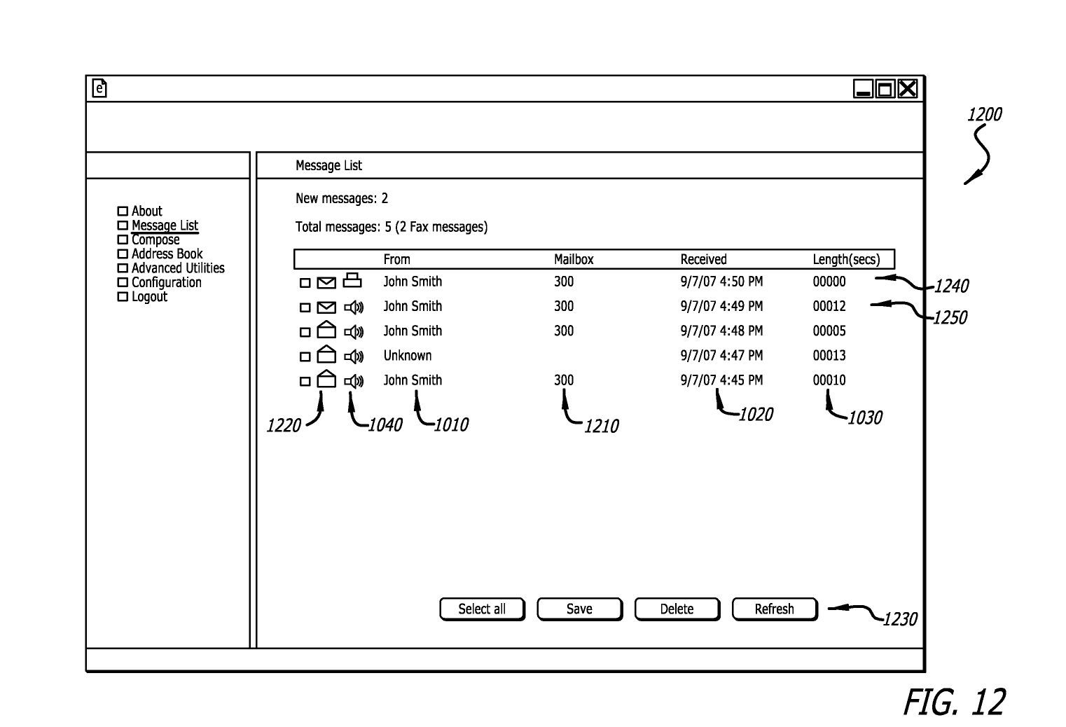

Referring now to FIG. 12, an illustrative embodiment of a message list 1200 displayed at the computing device of the user is shown. Message list 1200 is a compilation of stored voicemails represented by entries using the voicemail message information retrieved using the Message_IDs. The retrieved user properties establish the general layout of message list 1200 and each of the voicemail message entries includes (1) sender_name 1010; (2) the sender's mailbox number 1210; (3) VM_Time 1020; (4) VM_Length 1030 and (5) M_Flag 1040. In addition, message list 1200 includes an icon 1220 placed to the left of M_Flag 1040. Icon 1220 identifies whether the message has been reviewed.

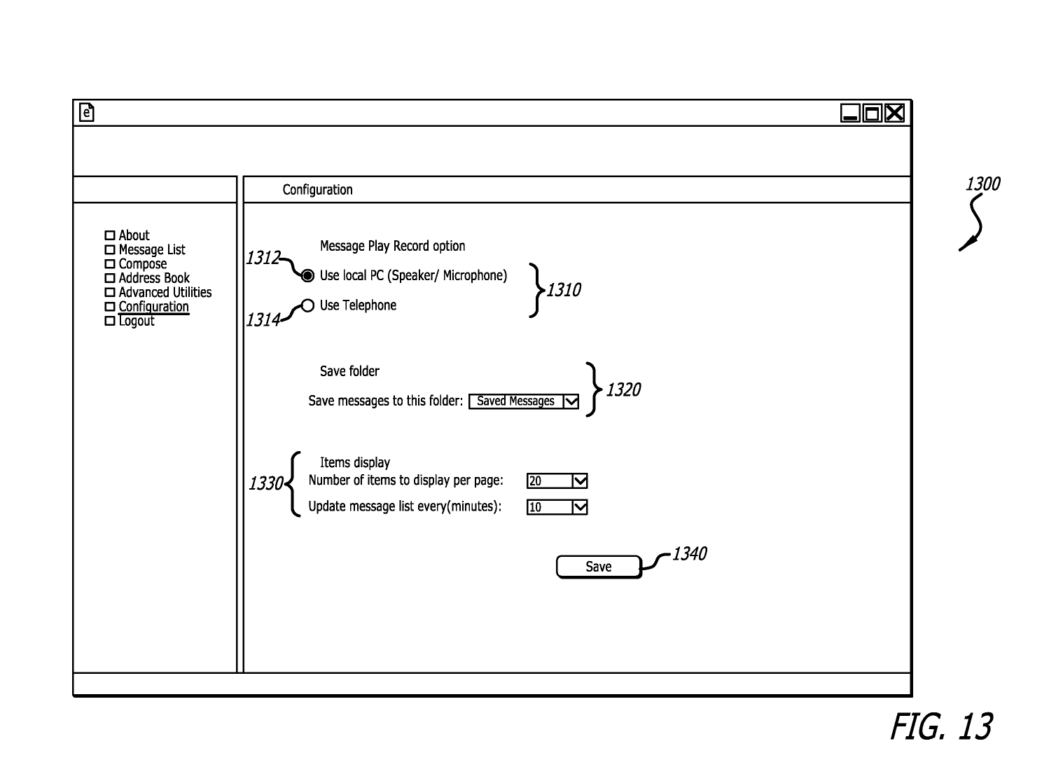

Control buttons 1230 are located at the bottom of message list 1200 in order to control selection of the messages as well as saving the messages in a selected folder or deleting the messages. A “refresh” button is also used in order to provide a user-controlled mechanism to refresh message list 1200 in lieu of a refresh time that was selected by the user in a configuration web page illustrated in FIG. 13.

As shown, a first message 1240 is a stored facsimile transmission from John Smith, a VMS user at mailbox #300. The facsimile transmission has not been opened as represented by icon 1220 and was received on September 7^{th} at 4:50 PM. Similarly, second message 1250 is a voicemail message from John Smith. The voicemail is twelve seconds in duration and has not been played back as represented by icon 1220. The voicemail was received on September 7^{th} at 4:49 PM.

Referring now to FIG. 13, configuration web page 1300 allows the user to configure the web page layout and select the device targeted to receive voicemail for playback. Configuration web page 1300 includes a message play/record option 1310, which allows the user to select the device that is used to play and record voicemail messages. As shown, a PC option 1312 is selected to play voicemail messages on speakers associated with the computing device and record audio in a microphone associated with the computing device. Alternatively, a telephone option 1314 can be selected and, if selected, at least one input field (not shown) is displayed to allow the user to select a particular telephone number in which voicemail messages are to be sent via the telephone switch 140 of FIG. 1 for playback or recordation. This enables the user to alter the destination device for voicemail messages in order to provide a more confidential environment as needed.

A second portion 1320 of configuration web page 1300 is to allow the user to select which folders voicemail messages are to be saved for further access as needed. Hence, voicemail messages may be downloaded to folders residing on the computing device.

A third portion 1330 of configuration web page 1300 allows the user to adjust user properties such as the number of items displayed per page and the refresh duration on which message list 1200 of FIG. 12 is updated. Upon select the values for these user properties, the “Save” button 1340 can be selected in order to save the entered data for subsequent use.

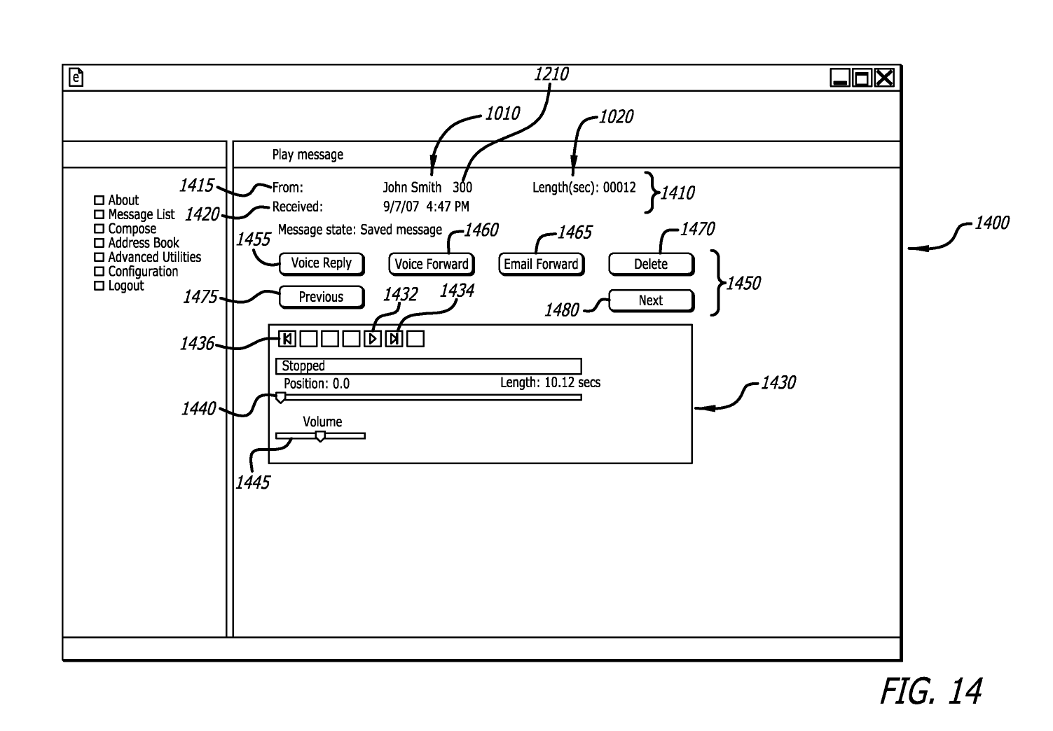

Referring now to FIG. 14, an illustrative embodiment of a web page generated in response to selection of a second voicemail message 1250 contained in message list 1200 of FIG. 12 is shown. This “Play message” 1400 includes a message summary section 1410, a tool bar 1430 to control the playback of first voicemail message 1240 and a reply/forward/delete control section 1450.

As shown, message summary section 1410 includes a first area 1415 to display sender_name 1010 and the sender's mailbox 1210. Tool bar 1430 provides the user with an ability to play the voicemail message upon selecting a play button 1432 located in tool bar 1430 of web page 1400. Upon selecting play button 1432, the computing device transmits a signal to the web server to retrieve this particular voicemail message from the VMS and download the voicemail message to computing device for playback. Of course, the voicemail message may be temporarily placed in the message cache to avoid repeated access of the VMS.

Fast Forward 1434 and Rewind 1436 buttons allow the user to adjust the content being played back. This adjustment can be further made through location bar 1440. The volume of the played back voicemail message can be adjusted through volume controls 1445.

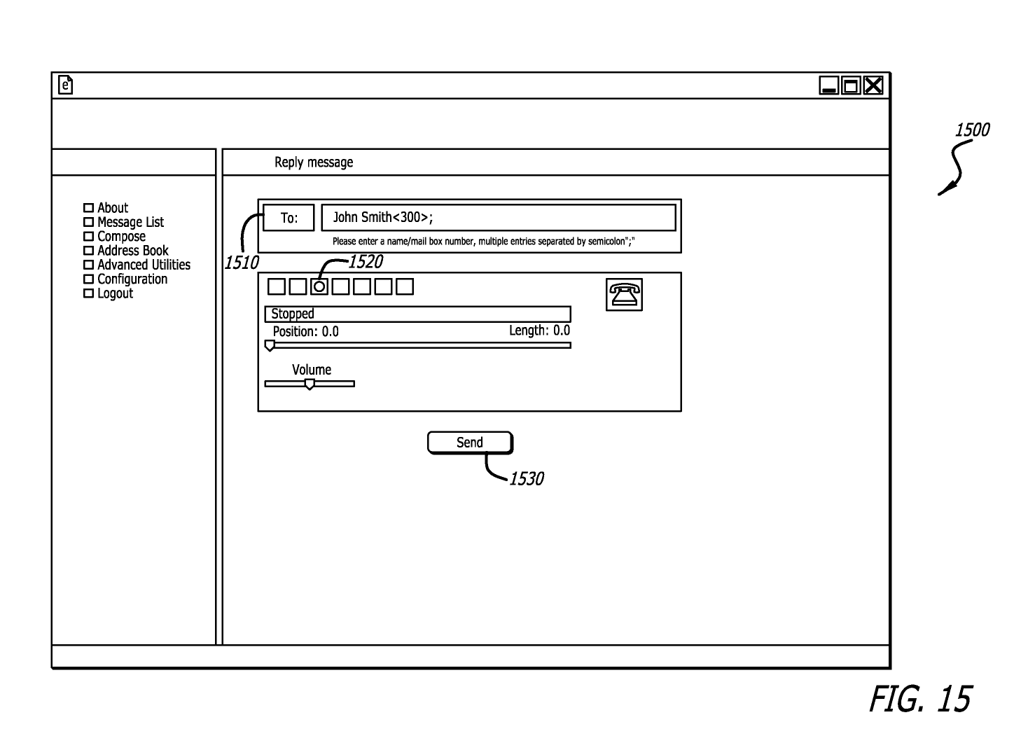

Reply/forward/delete control section 1450 includes a plurality of selectable buttons 1455, 1460, 1465, 1470, 1475 and 1480 that enable the user to perform an action involving the voicemail message. For instance, button 1455 enables the user to reply to the voicemail message. This involves the composition of a new voicemail message 1500 with the targeted recipient identified as the sender of the voicemail message (sender_name 1010 & mailbox number 1210) as shown in FIG. 15.

Upon selecting the “To:” button 1510, a pop-up menu (not shown) is created which allows the user to intelligently select additional recipients of Reply message 1500. This allows the user to select other VMS users for receipt of voicemail message 1500. A record button 1520 allows the user to record a voicemail message that is sent to the targeted recipient upon selection of “Send” button 1530.

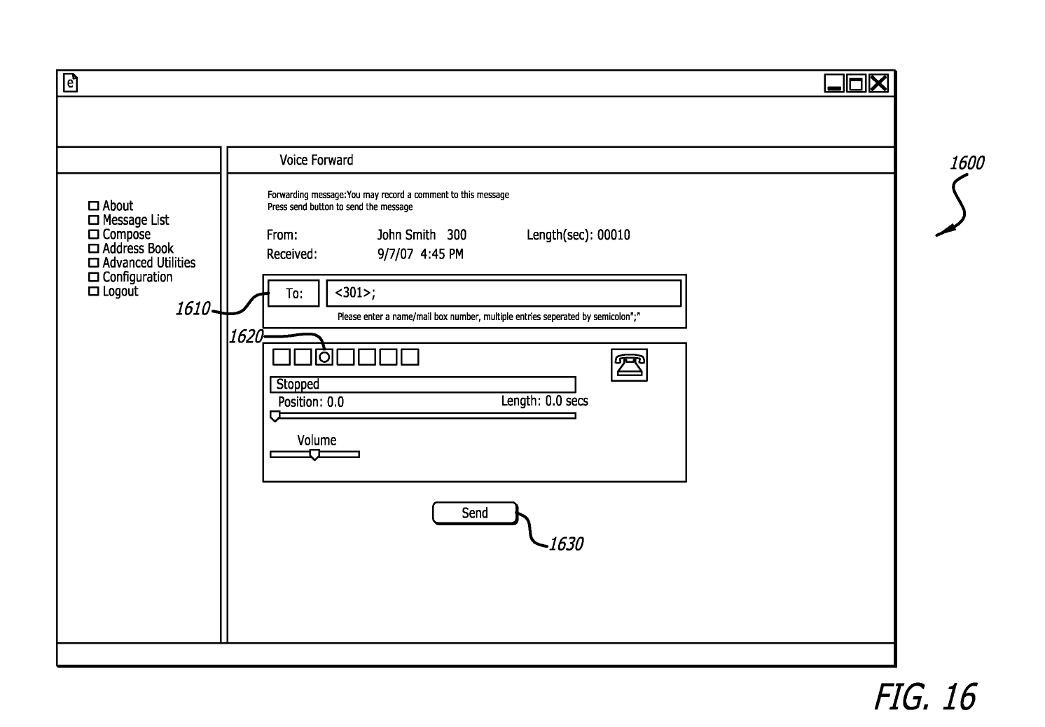

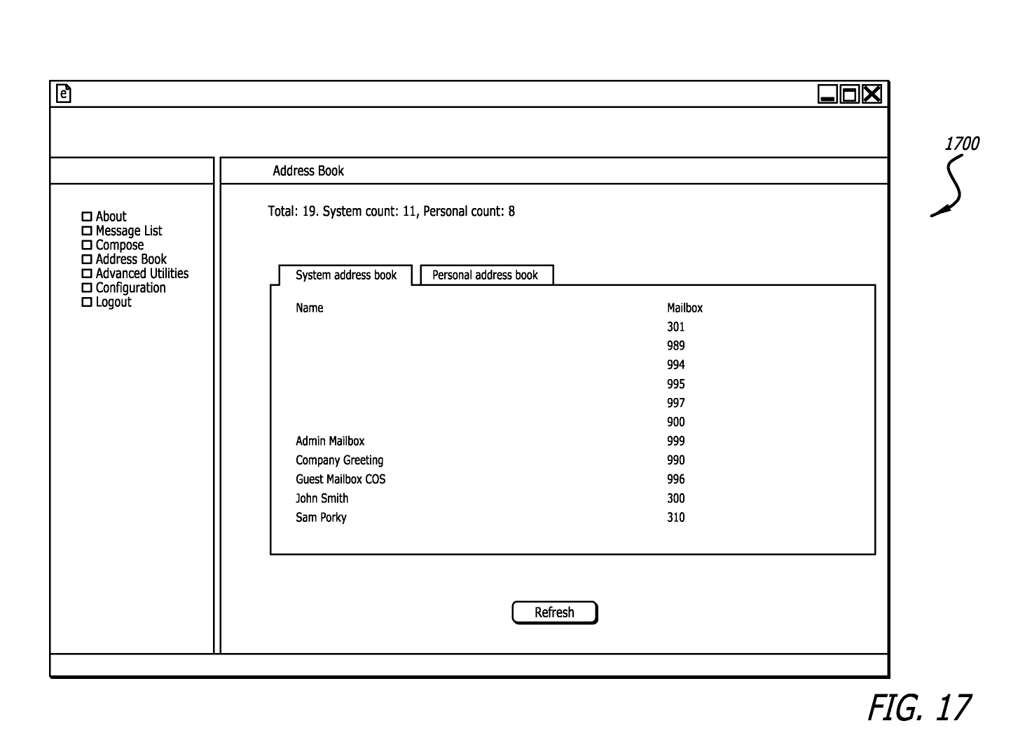

Referring back to FIG. 14, button 1460 enables the user to forward the voicemail message to another registered user of the VMS as shown in FIG. 16. As a result, a new voicemail message 1600 is generated with no targeted recipient. Rather, the targeted recipient(s) is(are) chosen by selecting “To:” button 1610, which accesses address book 1700 shown in FIG. 17. Address book 1700 is formulated from all owner names (if entered) and mailbox numbers retrieved from VMS 110_{M} as shown in FIG. 7. Herein, an unnamed user at mailbox #301 is selected.

A record button 1620 allows the user to record a voicemail message that, upon selection of “Send” button 1630, is also sent with the Message_ID of the forwarded voicemail message to the VMS for download to the targeted recipient(s).

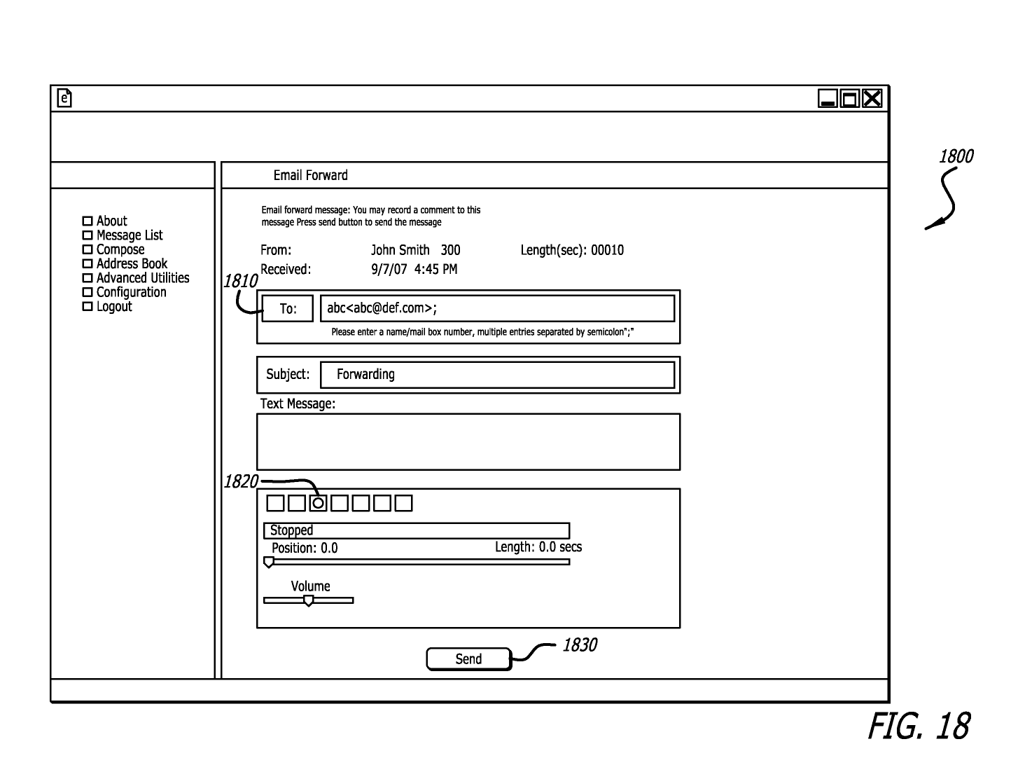

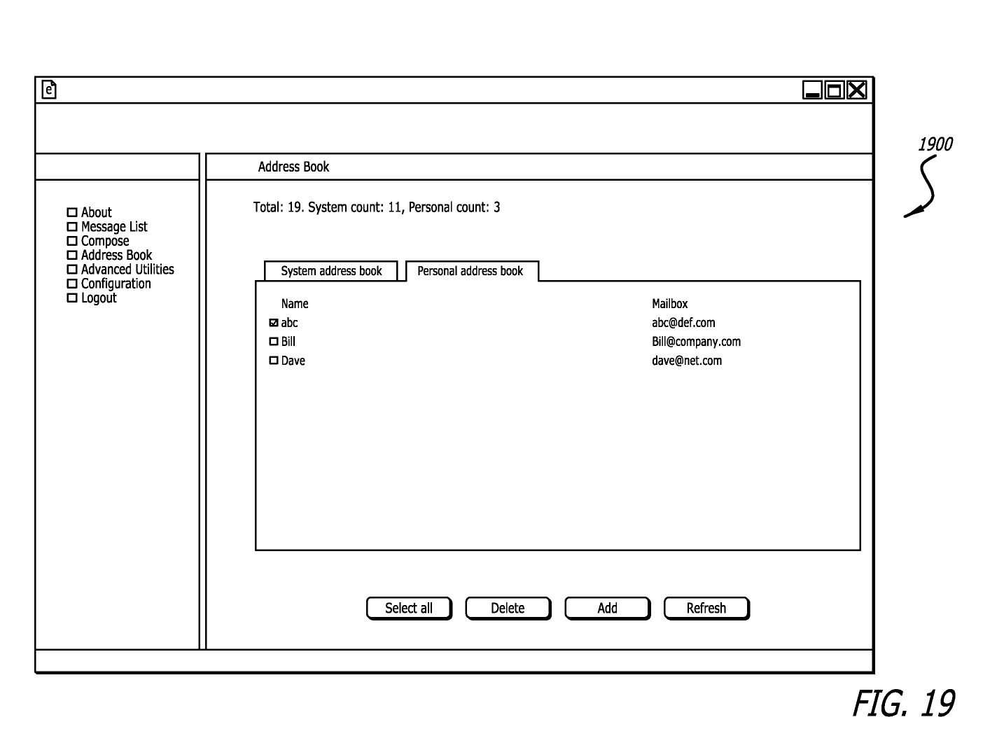

Referring back to FIG. 14, button 1465 enables the user to forward the voicemail message over the Internet to a targeted email recipient. As a result, a new voicemail message 1800 is generated with no targeted recipient as shown in FIG. 18. Instead, the targeted recipient(s) is chosen by selecting “To:” button 1810, which accesses email address book 1900 shown in FIG. 19. Address book 1900 is formulated from stored email addresses retrieved from internal storage within VMS and/or the email server 130 accessible through the VMS as shown in FIG. 8. A record button 1820 allows the user to record a voicemail message that is compressed and converted into a .WAV format for attachment to a resultant email upon selection of “Send” button 1830.

Besides forwarding voicemail message 1800 to a targeted email recipient, the user could also add text messaging information in addition to an audio message. The text messaging information 1840 is inserted into text message field 1840 to provide the targeted recipient information without playback of the voicemail message or additional information.

Referring back to FIG. 14, the “Delete” button 1470 allows the voicemail message to be deleted while “Previous” and “Next” buttons 1475 and 1480 generate instructions for the retrieval of stored messages before or after the recovered voicemail message.

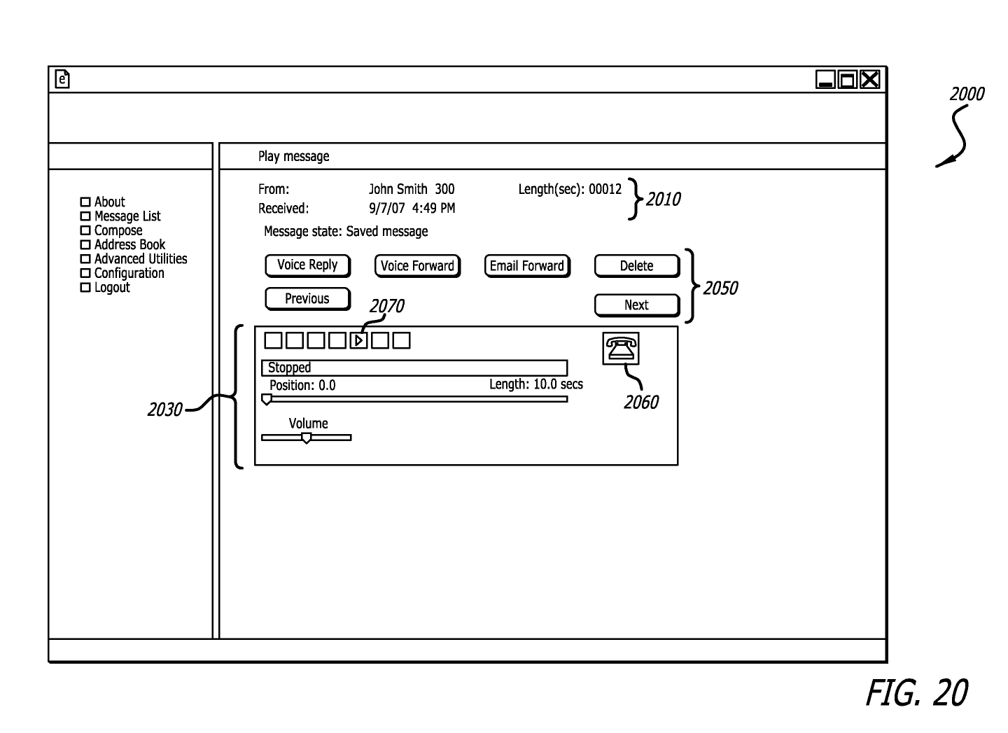

Referring now to FIG. 20, a second illustrative embodiment of a Play message web page 2000 is shown. Herein, after selection of a first voicemail message 1240 contained in message list 1200 of FIG. 12, play message web page 2000 is displayed. Similar to FIG. 14, “Play Message” simply operates as a web page and includes a message summary section 2010, a tool bar 2030 to control the playback of first voicemail message 1240 and a reply/forward/delete control section 2050. However, play message web page 2000 further includes an icon 2060 that identifies the destination for playback of voicemail to another device (e.g., cell phone). Hence, upon selecting a play button 2070, the computing device sends a message to the web server to retrieve the voicemail message, and instead of returning to the computing device, routes the voicemail message via the telephone switch to the selected phone number of the device.

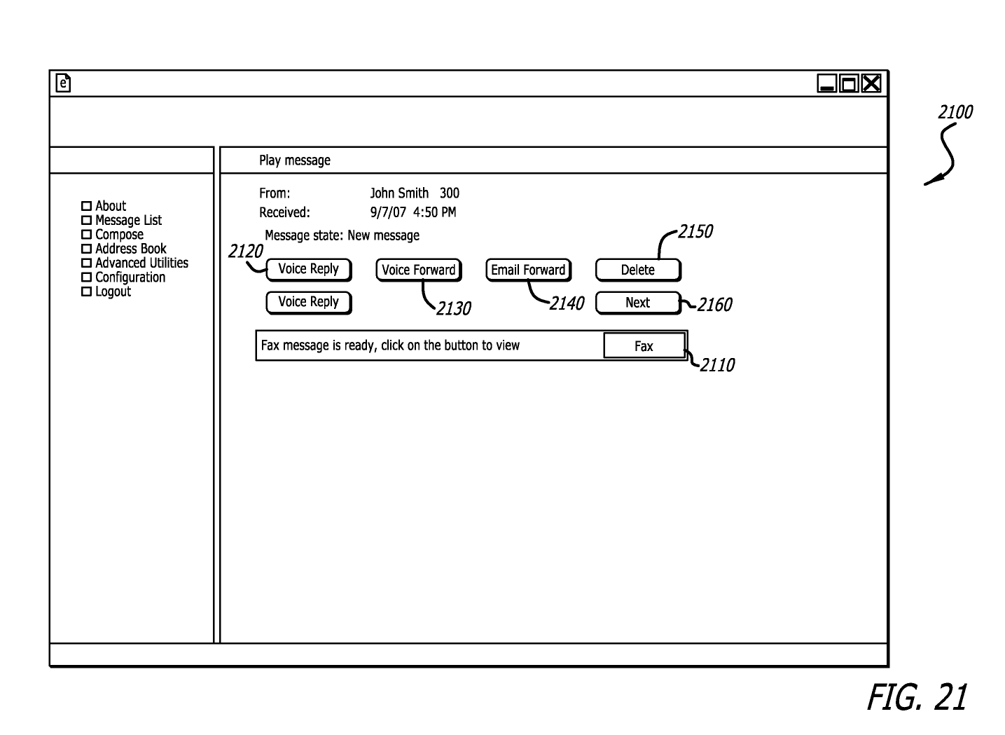

Referring to FIG. 21, an illustrative embodiment of a web page generated upon selection of first message 1240 contained in message list 1200 of FIG. 12 is shown. First message 1240 constitutes a facsimile transmission that has been stored in the VMS, where VM_Length is set to “0”. Upon selection, a “Play message” web page 2100 is produced that allows the user to view the fax message by selection of button 2110. In addition, a voicemail message may be recorded and returned to the VMS user who sent the facsimile transmission (Reply button 2120) or the voicemail message may be forwarded to another VMS user (Voice Forward button 2130). The facsimile transmission may be forwarded to a chosen email address upon selection of Email Forward button 2140 or deleted upon selection of Delete button 2150. A Previous and Next button 2160 provides a short-cut to play the previous or next message within message list 1200 of FIG. 12 without having to return to that web page.

While the invention has been described in terms of several embodiments, the invention should not limited to only those embodiments described, but can be practiced with modification and alteration within the spirit and scope of the appended claims. The description is thus to be regarded as illustrative instead of limiting.

What is claimed is:

1. Performed by a web server, a method comprising:
establishing communications with a voicemail system; and
controlling processing of content stored within the voicemail system by a computing device remotely located from the voicemail system and in communication with the web server.

2. The method of claim 1 wherein the establishing of communications with the voicemail system comprises:
receiving a message from the computing device to establish the logical connection with the voicemail system, the message including an identifier of the voicemail system, a mailbox number associated with a user accessing a voicemail account, and an input password; and
establishing a logical connection with the voicemail system after the voicemail system confirms that the mailbox number is supported by the voicemail system and the input password matches a pre-stored password previously established by the user.

3. The method of claim 2 wherein the establishing of the logical connection further occurs after determining if remote access functionality is enabled for the voicemail system before allowing remote access to the voicemail system from the web server.

4. The method of claim 1 wherein the controlling of processing of the stored content within the voicemail system, comprises:
retrieving user properties and system parameters, the user properties including information used to personalize a displayable layout of a web page including the stored content.

5. The method of claim 1 wherein the user properties include at least two of a number of lines per web page, a number of messages displayed within a message list displayable on the computing device, and an interim time period between refresh operations to update the message list.

6. The method of claim 1 wherein the controlling of processing of the stored content within the voicemail system, comprises:
retrieving names and mailbox numbers assigned to all owners of voicemail accounts within the voicemail system, the names and mailbox numbers being used to generate a system address book.

7. The method of claim 2 wherein the controlling of processing of the stored content within the voicemail system, comprises:
retrieving email addresses associated with the user of the voicemail account within the voicemail system, the email addresses being used to generate a personal address book.

8. The method of claim 1 wherein the controlling of the processing of the stored content within the voicemail system, comprises:
generating a message list based on information recovered from the voicemail system, the message list to display a plurality of voicemail messages being at least part of the stored content within the voicemail system; and
accessing a first voicemail message of the plurality of voicemail messages within the voicemail system in response to the message from the computing device.

9. The method of claim 8 wherein the accessing of the first voicemail message includes deleting the first voicemail message stored within the voicemail system.

10. The method of claim 8 wherein the accessing of the first voicemail message comprises:
downloading the first voicemail message from the voicemail system, the first voicemail message being previously stored within the voicemail system; and
playback of the first voicemail message on the computing device.

11. The method of claim 8 wherein the accessing of the first voicemail message comprises:
providing a message from the computing device to request the voicemail system to transmit the first voicemail message to a portable electronic device accessible over a public switched network using a selected telephone number; and
playback of the voicemail message on the portable electronic device.

12. The method of claim 11 wherein the playback of the voicemail message on the portable electronic device occurs contemporaneously with retained communications between the web server and the voicemail system.

13. A communication system comprising:
a voicemail system including a database to store digital content represented as voicemail messages and a server; and
a web server coupled to the server of the voicemail system, the web server being adapted to control processing of digital content stored within the voicemail system and to retrieve the digital content as prompted by a computing device for either display or playback at the computing device.

14. The communication system of claim 13 wherein the web server establishes a peer-to-peer logical connection with the voicemail system in response to a request message from the computing device.

15. The communication system of claim 13 wherein the web server to control processing of the digital content by deleting a voicemail message stored within the voicemail system based on a request received from the computing device.

16. The communication system of claim 13 wherein the web server to control processing of the digital content by requesting the voicemail system to route a stored voicemail message to a portable electronic device for playback, the portable electronic device being different than the computing device.

17. The communication system of claim 13 wherein the web server to control processing of the digital content by requesting the voicemail system to route a stored voicemail message to the computing device for playback.

18. Software embodied within machine-readable medium and executed by a processor implemented within a web server, the software comprising:
a first module to detect a message from a computing device requesting information from the voicemail system over an Internet connection and to initiate a request message to the voicemail system on behalf of the computing device; and
a second module to receive the information as requested by the request message and providing the information to the computing device, thereby allowing the computing device to remotely control the voicemail system over the Internet connection.
